(19) United States
(12) Patent Application Publication
(10) Pub. No.: US 2019/0050161 A1
(43) Pub. Date: Feb. 14, 2019

(54) DATA STORAGE CONTROLLER

(71) Applicant: Intel Corporation, Santa Clara, CA (US)

(72) Inventors: Piotr Wysocki, Gdansk (PL); Slawomir Ptak, Gdansk (PL); Kapil Karkra, Chandler, AZ (US); Marcin Pioch, Gdansk (PL)

(21) Appl. No.: 16/014,550

(22) Filed: Jun. 21, 2018

(51) Int. Cl. G06F 3/06; G06F 13/16; G06F 11/10

(52) U.S. Cl. CPC G06F 3/0634; G06F 13/1673; G06F 11/1008; G06F 3/0688; G06F 2003/0697; G06F 2212/214; G06F 2003/0691; G06F 2212/403; G06F 3/0619

(57) ABSTRACT

Embodiments of the present disclosure may relate to a data storage apparatus that may include a redundancy logic to determine recovery data based on data in a storage region buffer; and a storage region controller to schedule a first set of non-volatile memory (NVM) dies in a first solid state drive (SSD) to be in a non-deterministic (ND) state or a deterministic (D) state, schedule a second set of NVM dies in a second SSD to be in a ND state or a D state, issue a first write command to write the data to the first set of NVM dies when the first set of NVM dies are in the ND state, and issue a second write command to write the recovery data to the second of NVM dies when the second set of NVM dies are in the ND state. Other embodiments may be described and/or claimed.

### FIELD

Embodiments of the present disclosure generally relate to the field of computer data storage devices and, more particularly, to devices and techniques that provide predictable read latency for computer data storage devices.

### BACKGROUND

Data may be stored in non-volatile memory (NVM) in a Solid State Drive (SSD). The NVM may be NAND Flash memory. As the capacity of SSDs increases, the number of Input/Output (I/O) requests to the SSDs also increases and it is difficult to provide a predictable read latency (also referred to as deterministic reads). NAND Flash die collisions may occur with concurrent read and write requests to the same NAND Flash die, resulting in non-deterministic reads. For example, a request to read data from a NAND Flash memory die on a SSD may be stalled for a period of time waiting for a write, an erase, or a NAND Flash management operation on the NAND Flash memory die to complete. These non-deterministic reads may not be acceptable for some applications that may require guaranteed deterministic reads during some time periods.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 depicts a block diagram of a computer system that includes a storage region controller, in accordance with various embodiments.

FIG. 2 is a timing diagram that shows state scheduling of NVM dies, in accordance with various embodiments.

FIG. 3 depicts a block diagram that shows a write operation to three sets of NVM dies in two SSDs, in accordance with various embodiments.

FIG. 4 is a flow diagram of a technique for writing data to sets of NVM dies in a plurality of SSDs, in accordance with various embodiments.

FIG. 5 depicts a block diagram that shows a read operation from three sets of NVM dies in two SSDs, in accordance with various embodiments.

FIG. 6 is a flow diagram of a technique for reading data from sets of NVM dies in a plurality of SSDs, in accordance with various embodiments.

FIG. 7 schematically illustrates an example computing device that includes a data storage apparatus as described herein, in accordance with various embodiments.

FIG. 8 illustrates an example storage medium with instructions configured to enable an apparatus to practice various aspects of the present disclosure, in accordance with various embodiments.

### DETAILED DESCRIPTION

Embodiments of the present disclosure may relate to a data storage apparatus that may include a redundancy logic to determine recovery data, based at least in part on data in a storage region buffer, and a storage region controller. In some embodiments, the storage region controller may schedule a first set of non-volatile memory (NVM) dies in a first solid state drive (SSD) to be in a non-deterministic (ND) state or a deterministic (D) state, schedule a second set of NVM dies in a second SSD to be in a ND state or a D state, issue a first write command to write the data to the first set of NVM dies when the first set of NVM dies are in the ND state, and issue a second write command to write the recovery data to the second of NVM dies when the second set of NVM dies are in the ND state. In some embodiments, the recovery data may be parity data, and the redundancy logic may determine the parity data based on an exclusive OR (XOR) operation. In various embodiments, the storage region controller may schedule the first set of NVM dies and the second set of NVM dies via a NVM Express (NVMe) interface, an open channel SSD interface, or any other suitable interface.

In the following description, various aspects of the illustrative implementations will be described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations are set forth in order to provide a thorough understanding of the illustrative implementations. It will be apparent to one skilled in the art that embodiments of the present disclosure may be practiced without the specific details. In other instances, well-known features are omitted or simplified in order not to obscure the illustrative implementations.

In the following detailed description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

As used herein, the term “module” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable components that provide the described functionality.

Non-Volatile Memory Express (NVMe) standards define a register level interface for host software to communicate with a non-volatile memory subsystem (for example, a Solid State Drive (SSD)) over Peripheral Component Interconnect Express (PCIe), a high-speed serial computer expansion bus. The NVM Express standards are available at www.nvmexpress.org. The PCIe standards are available at pcisig.com.

Open Channel SSD is a SSD interface that allows fine grained control over data placement on NAND Flash Dies and drive background operations. The Open Channel SSD specification is available at lightnvm.io. Some embodiments may include sets of NVM dies that are accessed using an Open Channel SSD interface.

In some embodiments, a host system may communicate with a plurality of Solid State Drives (SSDs) using an NVMe over PCIe standard. In various embodiments, data may be written across many NAND Flash dies in the SSDs to optimize the bandwidth. In some embodiments, the data may be written as a stripe across NAND flash dies.

Some embodiments may relate to a NVMe sets feature and/or deterministic/non-deterministic states of the NVMe sets in particular time windows, which may also be referred to as timeslots. In various embodiments, the NVMe sets feature may include a technique to partition non-volatile memory in a plurality of SSDs into sets, which may split the non-volatile memory into groups of NAND Flash dies. In some embodiments, deterministic/non-deterministic windows may allow SSD internal operations to be stalled during deterministic windows to avoid host and SSD internal I/O collisions, and to allow a maintenance mode during non-deterministic windows when SSD internal operations may be performed. In some embodiments, a deterministic window may be a time period in which a host performs only reads. In various embodiments, the host may transition the NVM set from a non-deterministic state to a deterministic state explicitly using a standard NVMe command or implicitly by not issuing any writes for a time period. Alternatively, in some embodiments, a host may monitor a NVM set's internal state using NVMe mechanisms to ensure that the NVM Set has reached a desired level of minimum internal activity where reads will likely not incur collisions and quality of service (QoS) issues.

In some embodiments, a NVMe set may be a set of NAND Flash dies grouped into a single, contiguous Logical Block Address (LBA) space in an NVMe SSD. In some embodiments, a NVMe set may be a single NAND Flash die, directly addressable (by Physical Block Address (PBA)) located in an Open Channel type SSD. In some embodiments, an NVMe set may be a Quality of Service (QoS) isolated region of a SSD. In various embodiments, a write to NVMe set A may not impact a read to NVMe set B or NVMe set C. In some embodiments, the NVMe set may define a storage domain where collisions may occur between Input/Output (I/O) operations.

In some embodiments, a host based I/O scheduling system (e.g., in a device driver or storage stack of an OS) may improve read latency by reducing I/O collisions and improving I/O determinism of NVMe over PCIe and/or Open Channel SSDs. In various embodiments, the host based I/O scheduling system may include redundancy logic to generate data redundancy across storage regions (“NVMe Sets”) in SSDs, an NVMe Set scheduler (e.g., a storage region controller) to schedule deterministic and non-deterministic states, and a storage region buffer to provide a predictable storage device read latency. In some embodiments, the storage region buffer may be a storage region write-back cache.

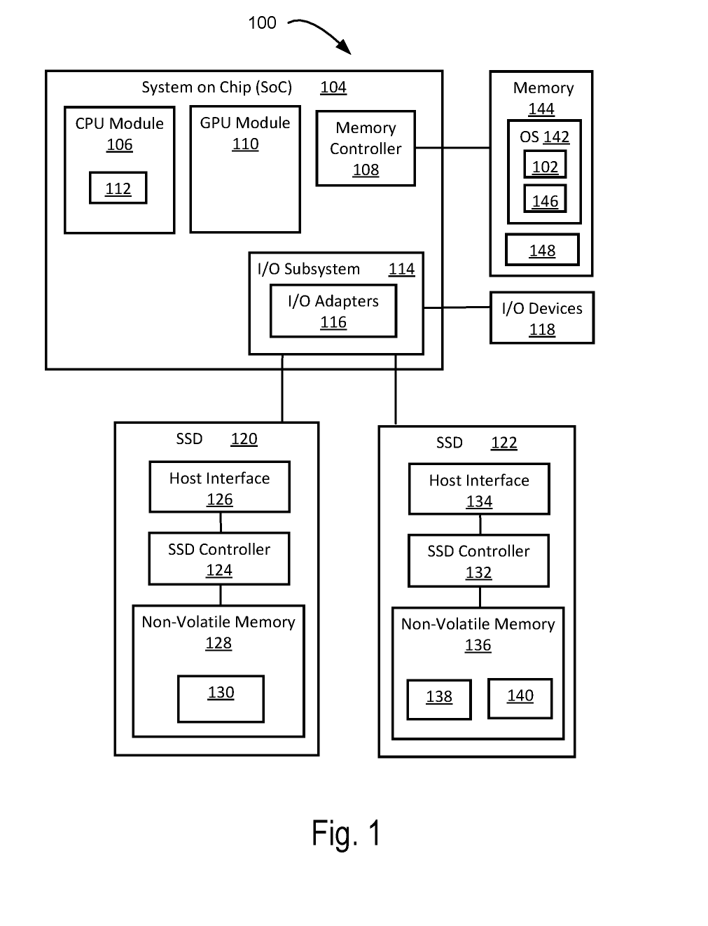

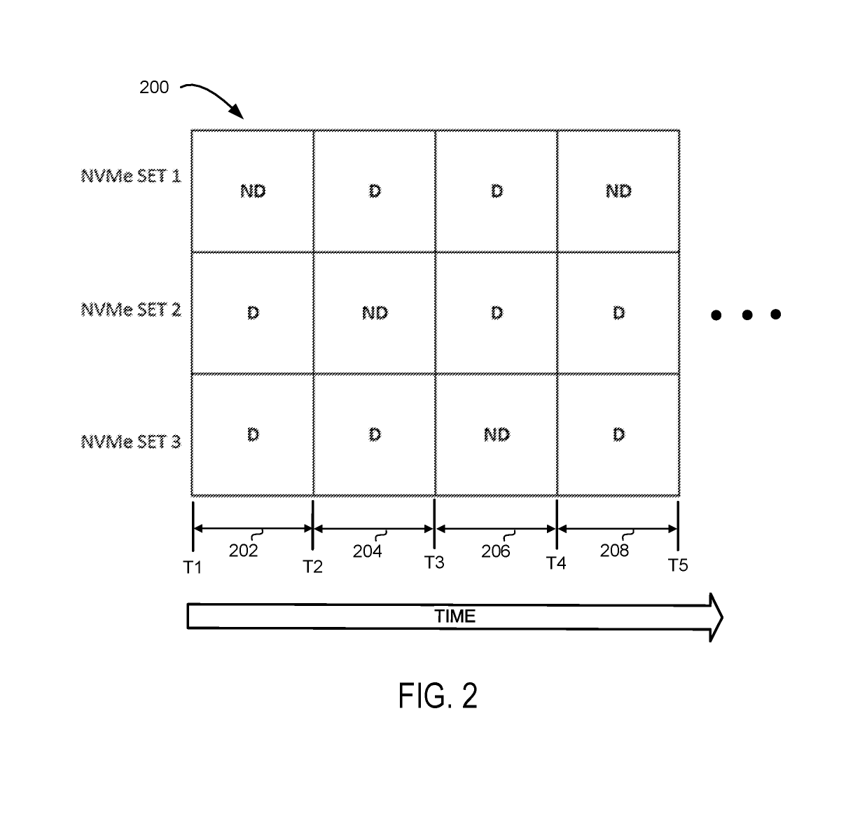

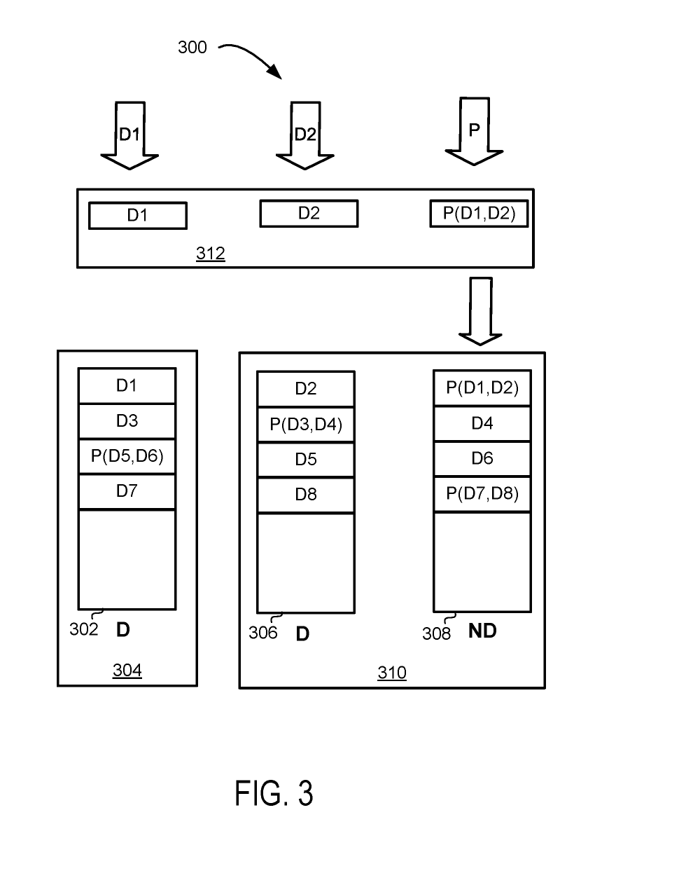

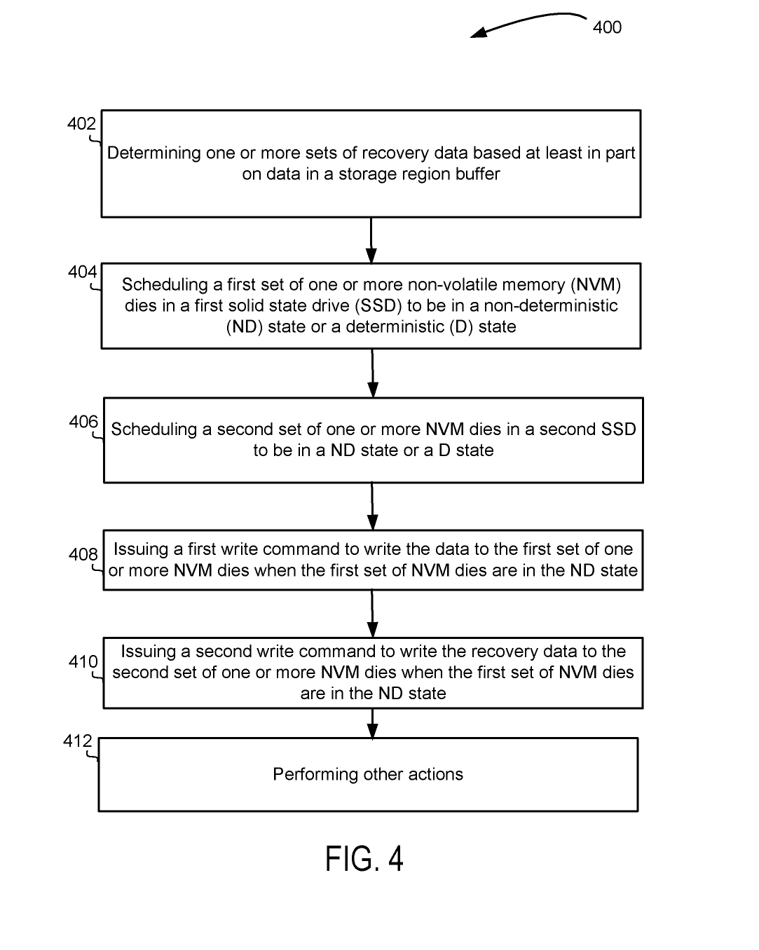

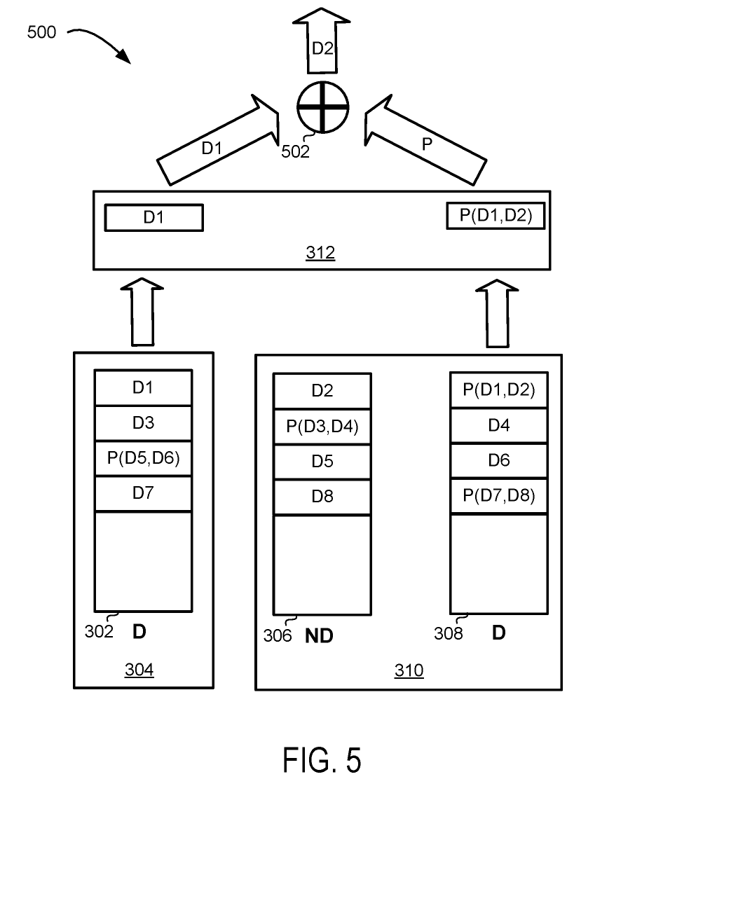

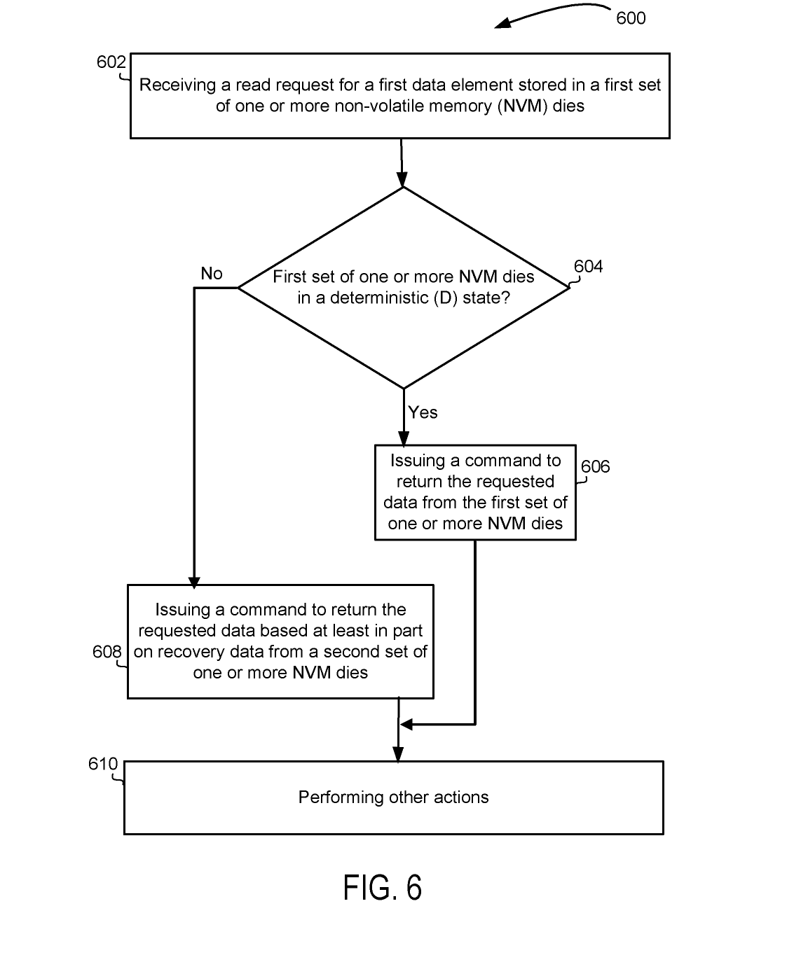

FIG. 1 is a block diagram of a computer system 100 that may include a storage region controller 102, in accordance with various embodiments. In various embodiments, the storage region controller 102 may schedule deterministic and non-deterministic states of sets of NVM dies as described with respect to FIG. 2, may control writes to sets of NVM dies in a plurality of SSDs as described with respect to FIGS. 3 and 4, and/or may control reads from sets of NVM dies as described with respect to FIGS. 5 and 6. In some embodiments, the computer system 100 may correspond to a computing device including, but not limited to, a server, a workstation computer, a desktop computer, a laptop computer, a tablet computer, and/or any other suitable computing device. In various embodiments, the computer system 100 may include a system on chip (SOC or SoC) 104 which may combine processor, graphics, memory, and Input/Output (I/O) control logic into one SoC package. The SoC 104 may include at least one Central Processing Unit (CPU) module 106, a memory controller 108, and a Graphics Processor Unit (GPU) 110. In various embodiments, the CPU module 106 may include one or more processor cores 112. Although not shown for clarity, each processor core 112 may internally include one or more instruction/data caches, execution units, prefetch buffers, instruction queues, branch address calculation units, instruction decoders, floating point units, retirement units, and/or any other suitable components in various embodiments. The CPU module 106 may correspond to a single core or a multi-core general purpose processor, such as those provided by Intel® Corporation, according to some embodiments.

In some embodiments, the GPU 110 may include one or more GPU cores and a GPU cache, which may store graphics related data for the GPU core. The GPU core may internally include one or more execution units and one or more instruction and data caches. Additionally, the GPU 110 may contain other graphics logic units that are not shown for clarity in FIG. 1, such as one or more vertex processing units, rasterization units, media processing units, and/or codecs.

In various embodiments, the SoC 104 may include an I/O subsystem 114. Within the I/O subsystem 114, one or more I/O adapter(s) 116 may be present to translate a host communication protocol utilized within the processor core(s) 112 to a protocol compatible with particular I/O devices. In some embodiments, the protocols may include one or more of Peripheral Component Interconnect (PCI)-Express (PCIe); Universal Serial Bus (USB); Serial Advanced Technology Attachment (SATA); Institute of Electrical and Electronics Engineers (IEEE) 1594 “Firewire”; and/or any other suitable protocol.

The I/O adapter(s) 116 may communicate with external I/O devices 118 which may include, for example, user interface device(s) including a display, a touch-screen display, printer, keypad, keyboard, wired and/or wireless communication logic, storage device(s) including hard disk drives (“HDD”), removable storage media, Digital Video Disk (DVD) drive, Compact Disk (CD) drive, Redundant Array of Independent Disks (RAID), tape drive or other storage device, in various embodiments. Additionally, in some embodiments, there may be one or more wireless protocol I/O adapters. In some embodiments, the wireless protocols may include a wireless protocol used in personal area networks, such as IEEE 802.15 and/or Bluetooth, 4.0; a wireless local area networking protocol, such as an IEEE 802.11-based wireless protocol; cellular protocols; and/or any other suitable wireless protocol.

In some embodiments, the I/O adapter(s) 116 may also communicate with a first solid-state drive (“SSD”) 120 and a second SSD 122. In various embodiments, the first SSD 120 may include a SSD controller 124, a host interface 126 and non-volatile memory 128 that may include one or more non-volatile memory devices that may include a first set of NVM dies 130. In various embodiments, the second SSD 122 may include a SSD controller 132, a host interface 134, and NVM 136 that may include a second set of NVM dies 138 and a third set of NVM dies 140. In various embodiments, the first set of NVM dies 130 may be a first NVMe set, the second set of NVM dies 138 may be a second NVMe set, and/or the third set of NVM dies 140 may be a third NVMe set.

In some embodiments, a non-volatile memory (NVM) device (e.g., NVM 128 and/or NVM 136) may be a memory whose state is determinate even if power is interrupted to the device. In some embodiments, the NVM device may include a block addressable mode memory device, such as NAND or NOR technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). In some embodiments, a NVM device may include a byte-addressable write-in-place three dimensional crosspoint memory device, or other byte addressable write-in-place NVM devices, such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric transistor random access memory (FeTRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, a combination of any of the above, or other suitable memory.

In some embodiments, an operating system (OS) 142 may be at least partially stored in an external memory 144. In various embodiments, the OS 142 may include the storage region controller 102 and/or a redundancy logic 146. In some embodiments, the redundancy logic 146 may determine one or more sets of recovery data (e.g., by computing parity with an XOR operation or by generating and/or storing a copy of one or more data elements) such as described with respect to FIGS. 3 and 4. In some embodiments, a portion of the external memory 144 may be reserved for a storage region buffer 148. In various embodiments, the storage region buffer 148 may be used in write and/or read operations. In some embodiments, the storage region buffer 148 may be a storage region write-back cache. In some embodiments, the storage region buffer 148 may be referred to as a storage region write buffer. In some embodiments, the storage region controller 102 may include the redundancy logic 146. The external memory 144 may be a volatile memory, a non-volatile memory, or a combination of volatile memory and non-volatile memory in various embodiments. In some embodiments, the storage region controller 102 and the storage region buffer 148 may be configured to provide a predictable read latency for reads from the first set of NVM dies 130 in the first SSD 120, and from the second set of NVM dies 138 and the third set of NVM dies 140 in the second SSD 122.

In various embodiments, a volatile memory may be a memory whose state (and the data stored in it) is indeterminate if power is interrupted to the device. In various embodiments, dynamic volatile memory may refresh the data stored in the device to maintain state. Examples of dynamic volatile memory may include DRAM (Dynamic Random Access Memory), or some variant thereof, such as Synchronous DRAM (SDRAM). In various embodiments, a memory subsystem as described herein may be compatible with a number of memory technologies, such as DDR3 (Double Data Rate version 3, original release by JEDEC (Joint Electronic Device Engineering Council) on Jun. 27, 2007); DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/Output version 2, JESD229-2 originally published by JEDEC in August 2014, HBM (High Bandwidth Memory, JESD325, originally published by JEDEC in October 2013, DDR5 (DDR version 5), LPDDR5, HBM2 (HBM version 2); other suitable memory technologies or combinations of memory technologies; and/or technologies based on derivatives or extensions of such specifications. The JEDEC standards are available at www.jedec.org.

In various embodiments, the storage region buffer 148 may store data to be written to NVM 128 in the first SSD 120, and to the NVM 136 in the second SSD 122. In addition to storing data to be written to the first SSD 120 and the second SSD 122, in some embodiments, data stored in the storage region buffer 148 may be provided to an application executing in a host. In some embodiments, all data to be written to the NVM 128 in the first SSD 120, and to the NVM 136 in the second SSD 122 may be first written to the storage region buffer 148 by the operating system 142.

In some embodiments, the storage region buffer 148 may be a portion of external memory 144 that may be byte addressable volatile memory, byte addressable write-in-place non-volatile memory, or a combination thereof. In other embodiments, the storage region buffer 148 may be a SSD that may include byte addressable write-in-place non-volatile memory and a NVMe over PCIe interface, or any other suitable storage device.

In some embodiments, the operating system 142 may be software that manages computer hardware and software including memory allocation and access to I/O devices. Examples of operating systems include Microsoft® Windows®, Linux®, iOS® and Android®. In an embodiment for the Microsoft® Windows® operating system, the storage region controller 102 may be included in a port/miniport driver of the device stack. In an embodiment for the Linux® operating system, the storage region controller 102 may be in a storage stack (a collection of hardware and software modules) above an NVMe driver. In various embodiments, operation of the storage region controller 102 may be transparent to applications running on a host system, such that the storage region controller 102, the redundancy logic 146, and/or the storage region buffer 148 may provide improved read determinism for data stored on multiple SSDs to unmodified applications (e.g., applications that are unaware of the D/ND state of NVM sets) running on the host system.

FIG. 2 is a timing diagram 200 that shows state scheduling for three sets of NVM dies, in accordance with various embodiments. Three sets of NVM dies are shown for purposes of illustration and clarity, but it should be understood that any suitable number of sets of NVM dies may be used in various embodiments. In some embodiments, a first set of NVM dies, NVMe SET 1, may correspond to the first set of NVM dies 130; a second set of NVM dies, NVMe SET 2, may correspond to the second set of NVM dies 138; and a third set of NVM dies, NVMe SET 3, may correspond to the third set of NVM dies 140. In various embodiments, to provide a predictable read latency, two states (a deterministic (D) state and a non-deterministic (ND) state) may be defined for scheduling I/O operations for the NVMe sets. In some embodiments, the storage region controller 102 may direct NVMe SET 1, NVMe SET 2, and/or NVMe SET 3 to switch from one state to the other (e.g., D to ND and/or ND to D). In some embodiments, the storage region controller 102 may generate one or more commands or instructions that may be provided to the first SSD 120 and the second SSD 122 to control the state (e.g., D or ND) of the first set of NVM dies 130, the second set of NVM dies 138, and the third set of NVM dies 140.

In various embodiments, the state of an NVMe set may change over time. As shown in FIG. 2, NVMe SET 1, NVMe SET 2, and NVMe SET 3 may have their D/ND states scheduled in time windows, shown as a first timeslot 202 from time T1 to time T2, a second timeslot 204 from time T2 to time T3, a third timeslot 206 from time T3 to time T4, and a fourth timeslot 208 from time T4 to time T5. In some embodiments, for each timeslot 202, 204, 206, 208, only one of the three NVMe sets may be in a ND state, as shown. However, it should be understood that a different number of NVMe sets may be used in some embodiments, and/or that more than one NVMe set may be in a ND state in a particular timeslot in some embodiments. In some embodiments, the duration of the timeslots may be based at least in part on a time required by firmware in the first SSD 120 and the second SSD 122 to perform background operations during the ND window. In some embodiments, each timeslot 202, 204, 206, 208 may be 500 milliseconds. However, it should be understood that any suitable duration may be used for the timeslots in various embodiments.

In various embodiments, when an NVMe set is in the ND state, both read operations and write operations may be allowed. For a write operation, data stored in the storage region buffer 148 when the NVMe set was in the D state may be flushed from the buffer 148 to the NVMe, and, in some embodiments, data not already stored in the storage region buffer 148 may be written to both the storage region buffer 148 and the NVMe set. In some embodiments, while in the ND state, the NVMe set may perform background operations and/or receive a trim command indicating which blocks of data stored in the NVMe set are no longer in use so that the NVMe set can erase and reuse them. In various embodiments, while the NVMe set is in the ND state, there may be no latency guarantee for read operations sent to the NVMe set. In some embodiments, the NVMe sets may not perform any internal background operations when in the D state to provide for deterministic read latency.

FIG. 3 is a block diagram of a write operation 300 to three sets of NVM dies in two SSDs, in accordance with various embodiments. Three sets of NVM dies and two SSDs are shown for purposes of illustration and clarity, but it should be understood that any suitable number of sets of NVM dies and/or SSDs may be used in various embodiments. In some embodiments, the write operation 300 may be performed with a first set of NVM dies 302 in a first SSD 304, a second set of NVM dies 306 in a second SSD 310, and a third set of NVM dies 308 in the second SSD 310. In some embodiments, the first SSD 304 may correspond to the first SSD 120, the second SSD 310 may correspond to the second SSD 122, the first set of NVM dies 302 may correspond to the first set of NVM dies 130, the second set of NVM dies may correspond to the second set of NVM dies 138, and the third set of NVM dies 308 may correspond to the third set of NVM dies 140. In some embodiments, the first set of NVM dies 302, the second set of NVM dies 306, and the third set of NVM dies 308 may be configured with a Redundant Array of Independent Disks (RAID) level 5 type data layout.

In various embodiments, a RAID data layout may combine a plurality of physical storage devices into a logical drive for purposes of reliability, capacity, and/or performance. A level 5 RAID system may provide a high level of redundancy by striping both data and parity information across at least three storage devices. Data striping may be combined with distributed parity to provide a recovery path in case of failure. In some embodiments, strips of a storage device may be used to store data. A strip may be a range of logical block addresses (LBAs) written to a single storage device in a parity RAID system. A RAID controller may divide incoming host writes into strips of writes across member storage devices in a RAID volume. A stripe is a set of corresponding strips on each member storage device in the RAID volume. In an N-drive RAID 5 system, for example, each stripe contains N−1 data strips and one parity strip. A parity strip may be the exclusive OR (XOR) of the data in the data strips in the stripe. The storage device that stores the parity for the stripe may be rotated per-stripe across the member storage devices. Parity may be used to restore data on a storage device of the RAID system should the storage device fail, become corrupted or lose power. Different algorithms may be used that, during a write operation to a stripe, calculate partial parity that is an intermediate value for determining parity.

In some embodiments, one or more of the RAID level data layouts (e.g., level 5, level 1, level 6, and/or any other suitable level) may be applied to a plurality of NVMe sets (e.g., first set of NVM dies 302, second set of NVM dies 306, and third set of NVM dies 308) in a plurality of SSDs to distribute data and redundancy data (e.g., parity data) among the NVMe sets.

As shown in FIG. 3, the first set of NVM dies 302 and the second set of NVM dies 306 are in the D state and the third set of NVM dies 308 is in the ND state. A first data element D1, a second data element D2, and a recovery data element may be stored in a storage region buffer 312 in various embodiments. In various embodiments, the recovery data element may be determined, computed, and/or generated by redundancy logic (e.g., redundancy logic 146). Although one recovery data element is shown for D1 and D2, it should be understood that in other embodiments, more than one recovery data element may be used for a particular set of data elements. In some embodiments, the recovery data element may be parity for data D1 and D2, indicated as P(D1, D2). In various embodiments, the storage region buffer 312 may correspond to the storage region buffer 148. In some embodiments, the storage region buffer 312 may be a storage region write-back cache. At the time shown, only P(D1, D2) may be written during the non-deterministic state to the third set of NVM dies 308. In some embodiments, a copy of the stripe (D1, D2, P(D1, D2)) may be stored in storage region buffer 312 until the entire stripe (D1, D2, P(D1, D2)) has been written to the first set of NVM dies 302, the second set of NVM dies 306, and the third set of NVM dies 308 to provide a predictable read latency for the stripe if a read request is received before one or more of the elements of the stripe have been written to the first set of NVM dies 302, the second set of NVM dies 306, and the third set of NVM dies 308. In some embodiments, a different data layout may be used (e.g., a RAID level 1 type data layout).

In some embodiments, the storage region buffer 312 may act like a write buffer. In various embodiments, all of the data to be written to the sets of NVM dies in the first SSD 304 and the second SSD 310 may be automatically written to the storage region buffer 312. Data to be written to a stripe may be stored in the storage region buffer 312 until the parity for the stripe has been written to one of the sets of NVM dies in the first SSD 304 or the second SSD 310. Until the entire stripe including parity has been written to the SSDs 304 and 310, the stripe (data) may be stored in the storage region buffer 312 so that it can be read with a predictable latency from the storage region buffer 312 if a read request is received before the parity has been written. In various embodiments, after the entire stripe including parity for the stripe has been written to all of the sets of NVM dies for the stripe in the SSDs 304 and 310, the stripe may be evicted from the storage region buffer 312.

As discussed earlier in conjunction with FIG. 2, write operations may be issued to an NVMe set when the NVMe set is in the ND state in various embodiments. In some embodiments, read requests to generate parity data to be stored in an NVMe set may also be issued when the NVMe set is in the ND state. In various embodiments, if a write to a NVMe set is sent when the NVMe set is in the D state, the data to be written to the NVMe set may be stored in the storage region buffer 312. In some embodiments, for each RAID level 5 type write operation to a stripe, parity may be computed and stored in the storage region buffer 312 to be written to a parity NVMe set. In some embodiments, the parity NVMe set may be the NVMe set in a stripe selected for storing parity for the stripe and may be written when the parity NVMe set is in the ND state. Additional data elements D3 to D8, are also shown stored with corresponding parity data P(D3, D4), P(D5, D6), and P(D7, D8) to illustrate that the parity data may be distributed among the first set of NVM dies 302, the second set of NVM dies 304, and the third set of NVM dies 308 in some embodiments.

In some embodiments, for each write operation, parity may be computed (e.g., by redundancy logic 146) and stored in the storage region buffer 312 to be written to a designated parity NVMe set for a particular stripe when the ND window is scheduled for the designated parity NVMe set. In some embodiments, a read-modify-write sequence may be used, that may include reading old data, performing an XOR operation of the old data with the new data and storing the result in the buffer, reading an old parity value when the ND window is switched to the designated parity NVMe set, performing an XOR operation of the cached value with the old parity value to calculate a new parity value, and writing the new parity value to the designated parity NVMe set.

In some embodiments, the size of the storage region buffer 312 may be dependent on and/or based at least in part on system workload. For example, the system workload may include constant write operations, bursts of write operations or write operations with strong locality. Strong locality may refer to a system workload in which a small range of LBAs, for example out of 16 Terabytes (TB) of total capacity of the solution, only 200 Megabytes (MB) may be overwritten. In some embodiments for a system with strong locality, all the data may be stored in buffer 312 with no need for a cache larger than 200 MB for parity.

For a constant write workload (e.g., a workload without write bursts), the size of the storage region buffer 312 may be about 10 MB in various embodiments. In some embodiments, a larger storage region buffer size may be used (e.g., approximately 2 Gigabytes (GB)), and may allow for a fast accommodation of bursts of writes. In some embodiments, if the workload has strong locality, the read and write performance may be significantly improved by the storage region buffer, due at least in part to a large hit ratio in the storage region buffer.

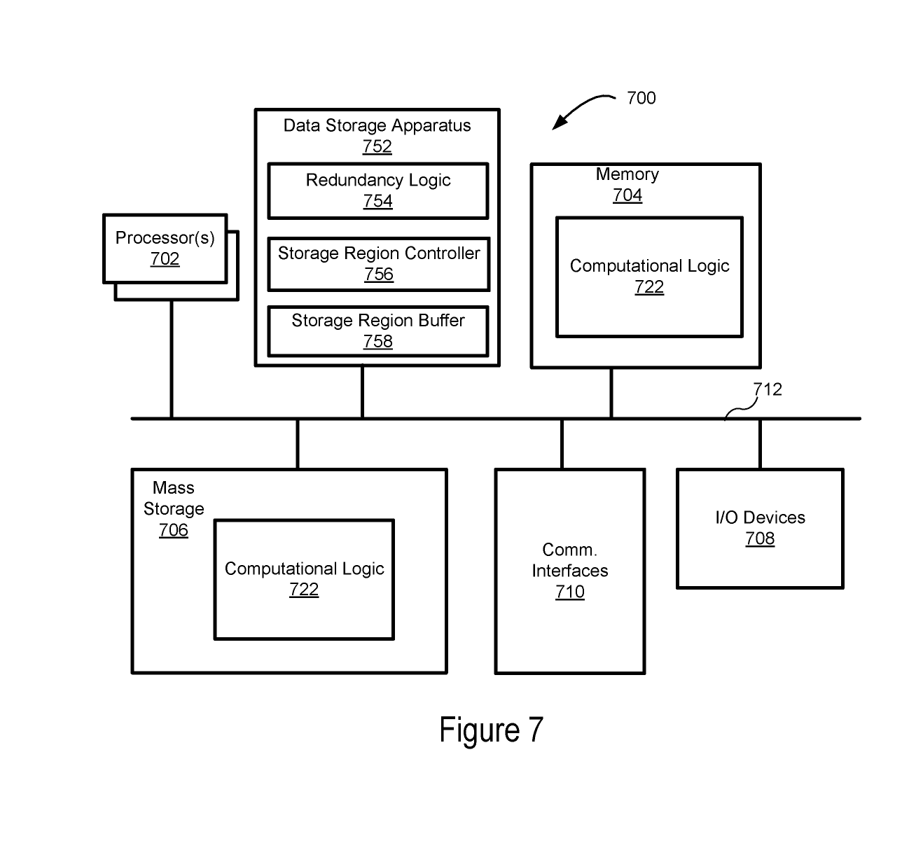

FIG. 4 is a flow diagram of a technique 400 for writing data to sets of NVM dies in a plurality of SSDs, in accordance with various embodiments. In some embodiments, some or all of the technique 400 may be practiced by components shown and/or described with respect to the computer system 100 of FIG. 1 or a portion thereof (e.g., storage region controller 102, redundancy logic 146, and storage region buffer 148), the computer device 700 of FIG. 7 or a portion thereof (e.g., storage region controller 756, redundancy logic 754, and storage region buffer 758 of data storage apparatus 752), or some other component shown or described herein with respect to any other Figure.

In some embodiments, at a block 402, the technique 400 may include determining one or more sets of recovery data (e.g., with redundancy logic 146 or redundancy logic 754), based at least in part on data in a storage region buffer (e.g., buffer 148 or buffer 312). In some embodiments, determining the one or more sets of recovery data may include performing an Exclusive OR (XOR) operation on a first data element (e.g., D1 of FIG. 3) and a second data element (e.g., D2 of FIG. 3) to generate parity data (e.g., P(D1, D2) of FIG. 3). However, it should be understood that any suitable technique for determining recovery data may be used (e.g, for a RAID 1 configuration, the recovery data may be determined to be a copy of a data element).

In various embodiments, at a block 404, the technique 400 may include scheduling a first set of one or more NVM dies (e.g., first set of NVM dies 130) in a first SSD (e.g., first SSD 120) to be in a ND state or a D state. In some embodiments, at a block 406, the technique 400 may include scheduling a second set of one or more NVM dies (e.g., second set of NVM dies 138) in a second SSD (e.g., second SSD 122) to be in a ND state or a D state. In various embodiments, at a block 408, the technique 400 may include issuing a first write command to write the data to the first set of one or more NVM dies when the first set of NVM dies is in the ND state. In some embodiments, at a block 410, the technique 400 may include issuing a second write command to write the recovery data to the second set of one or more NVM dies when the first set of NVM dies are in the ND state. In various embodiments, at a block 412, the technique 400 may include performing one or more other actions.

FIG. 5 is a block diagram of a read operation 500 from three sets of NVM dies in two SSDs, in accordance with various embodiments. In some embodiments, the three sets of NVM dies may be configured with a RAID level 5 type data layout as described with respect to FIG. 3. However, it should be understood that any suitable redundancy configuration may be used. As shown in FIG. 5, a stripe may include data D1, data D2 and parity generated for D1 and D2 (P(D1, D2)). The first set of NVM dies 302, storing D1, and the third set of NVM dies 308, storing parity P(D1, D2), are shown in a D state and may be read with a deterministic read latency according to some embodiments. The second set of NVM dies 306, storing D2, is shown in a ND state and may not be read at the time shown in FIG. 5, in accordance with various embodiments.

In some embodiments, in response to a request to read data D2, data for D1 and parity for D1 and D2, P(D1, D2), may be read from the first set of NVM dies 302 and the third set of NVM dies 308, respectively, into the storage region buffer 312. An XOR operation 502 may be performed on D1 and P(D1, D2) from the storage region buffer 312 to recover data D2, to be provided in response to the request to read data D2. In various embodiments, the read operation 500 may provide for a deterministic read latency for the read data D2, even when the set of NVM dies storing D2 is in a ND state, by reading from other sets of NVM dies currently in a D state, and performing the XOR operation 502 to recover D2 from other data that has a deterministic read latency at the time of the read request for D2.

In some embodiments, in response to a read request for a data element, the storage region controller 102 may first check whether the requested data element is in the storage region buffer 148 (which may correspond to the storage region buffer 312). If the data element is in the storage region buffer 148 (e.g., a cache hit), the data element may be read from the storage region buffer 148. If the data element is not in the storage region buffer 148 (e.g., a cache miss), the storage region controller may check to see whether the set of NVM dies in which the data element is stored is in a D state. If the set of NVM dies in which the data element is stored is in a D state, the data element may be read from the set of NVM dies in which it is stored. If the set of NVM dies in which the data element is stored is not in a D state, the data element may be recovered using other data elements stored in one or more sets of NVM dies that are in a D state (e.g., with one or more other data elements and parity data for a RAID level 5 type data configuration, or with a copy of the data element for a RAID level 1 type data configuration).

FIG. 6 is a flow diagram of a technique 600 for reading data from sets of NVM dies in a plurality of SSDs, in accordance with various embodiments. In some embodiments, some or all of the technique 600 may be practiced by components shown and/or described with respect to the computer system 100 of FIG. 1 or a portion thereof (e.g., storage region controller 102 and storage region buffer 148), the computer device 700 of FIG. 7 or a portion thereof (e.g., storage region controller 756 and storage region buffer 758 of data storage apparatus 752), or some other component shown or described herein with respect to any other Figure.

In some embodiments, at a block 602, the technique 600 may include receiving a read request for a first data element (e.g., D1 or D2 of FIG. 5) stored in a first set of one or more NVM dies (e.g., first set of NVM dies 302, second set of NVM dies 306, or third set of NVM dies 308). At a decision block 604, it may be determined whether the first set of one or more NVM dies is in a D state. If, at the decision block 604, it is determined that the first set of one or more NVM dies is in the D state, the technique 600 may proceed to a block 606. In some embodiments, at the block 606, the technique 600 may include issuing a command to return the requested data from the first set of one or more NVM dies.

In various embodiments, if it is determined at the decision block 604 that the first set of one or more NVM dies is not in the D state (e.g., in the ND state), the technique 600 may proceed to a block 608. In some embodiments, at the block 608, the technique 600 may include issuing a command to return the requested data based at least in part on recovery data (e.g., with XOR operation 502 using parity data P(D1, D2)) from a second set of one or more NVM dies. In some embodiments, the recovery data may include a copy of the requested data (e.g., for a RAID level 1 type data layout). In various embodiments, the technique 600 may include performing other actions (e.g., evicting one or more elements from a buffer) at a block 610.

As discussed above, some embodiments may use three sets of NVM dies with a RAID level 5 type data layout. In various embodiments, predictive read latency may be extended to more than two SSDs and/or may include a different number of sets of NVM dies. In some embodiments, the amount of parity data may also be adjusted. For example, in some embodiments, a predictive read may be applied to two sets of NVM dies in two SSDs for level 1 RAID. In some embodiments, a level 1 RAID system may improve read performance by writing data identically to two sets of NVM dies where a read request can be serviced by either set of NVM dies in the “mirrored sets”.

In some embodiments, the predictive read latency may also be applied to an N NVMe set for a level 6 RAID. A level 6 RAID system may provide a higher level of redundancy than a level 5 RAID system by allowing recovery from double storage device failures. In some embodiments with a level 6 RAID system, two syndromes, referred to as the P syndrome and the Q syndrome, may be generated for the data and stored on storage devices (e.g., sets of NVM dies) in the RAID system. The P syndrome may be generated by computing parity information for the data in a stripe (data blocks (strips), P syndrome block and Q syndrome block). The generation of the Q syndrome may use Galois Field multiplications. The regeneration scheme to recover data and/or P and/or Q syndromes performed during storage device recovery operations may use both Galois multiplication and inverse operations in various embodiments.

In some embodiments, there may be one redundancy group across all the NVMe sets (e.g., one RAID level 5 type volume). Various embodiments with one redundancy group may use the minimum storage dedicated to data redundancy (for example, to store data parity) but may use more read accesses to recover data in case of a read directed to an NVMe set in a ND state. In other embodiments, there may be multiple redundancy groups across all of the NVMe sets (e.g., multiple RAID level 1 type or RAID level 5 type volumes). Compared to embodiments having one redundancy group, various embodiments with multiple redundancy groups may use additional storage dedicated to data redundancy but may use less reads to recover data in case of a read directed to an NVMe set in a ND state. In addition, for some embodiments with multiple redundancy groups, multiple NVMe sets may be switched to a ND state at the same time, increasing the overall write bandwidth.

In some embodiments, each NVMe set may be included in a separate storage device. In some embodiments, erasure coding may be used to generate redundant data that may be used to reconstruct data stored in a storage device that is in the ND state when a request to read the data is received. Erasure coding transforms a message of k symbols into a longer message (code word) with n symbols such that the original message can be recovered from a subset of the n symbols. In some embodiments, all data used to recover a full message may be read from NVMe sets that are in the D state. RAID 5 and RAID 6 are special cases of erasure coding. Other examples of erasure coding include triple parity RAID and 4-parity RAID.

In various embodiments, user data (e.g., as stored in the sets of NVM dies of the first SSD 120 and the second SSD 122) may be maintained in a ‘deterministic’ state by providing read access to the data in a deterministic fashion, even if the set of NVM dies in which the data is stored is in a ND state at the time the data is requested. In some embodiments, providing read access to the data in a deterministic fashion may include avoiding host read-write collisions and read collisions with the storage device's (e.g., first SSD 120 or second SSD 122) internal operations. In various embodiments, providing read access to the data in a deterministic fashion may be performed without any awareness regarding avoidance of collisions by an application executing in the host.

Flow diagrams (e.g., FIG. 4 and FIG. 6) as illustrated herein provide examples of sequences of various process actions. In various embodiments, the flow diagrams may indicate operations to be executed by a software or firmware routine, as well as physical operations. In some embodiments, a flow diagram may illustrate the state of a finite state machine (FSM), which may be implemented in hardware and/or software. Although shown in a particular sequence or order, unless otherwise specified, the order of the actions may be modified. Thus, the illustrated embodiments should be understood only as an example, and the process may be performed in a different order, and some actions may be performed in parallel. Additionally, one or more actions may be omitted in various embodiments; thus, not all actions are required in every embodiment. Other process flows may be used in various embodiments.

To the extent various operations or functions are described herein, they may be described or defined as software code, instructions, configuration, and/or data. The content may be directly executable (“object” or “executable” form), source code, or difference code (“delta” or “patch” code). The software content of the embodiments described herein may be provided via an article of manufacture with the content stored thereon, or via a method of operating a communication interface to send data via the communication interface. A machine readable storage medium can cause a machine to perform the functions or operations described, and may include any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface may include any mechanism that interfaces to any of a hardwired, wireless, optical, etc., medium to communicate to another device, such as a memory bus interface, a processor bus interface, an Internet connection, a disk controller, etc. The communication interface may be configured by providing configuration parameters and/or sending signals to prepare the communication interface to provide a data signal describing the software content. The communication interface may be accessed via one or more commands or signals sent to the communication interface.

Various components described herein may be a means for performing the operations or functions described. Each component described herein may include software, hardware, or a combination of these. The components may be implemented as software modules, hardware modules, special-purpose hardware (e.g., application specific hardware, application specific integrated circuits (ASICs), digital signal processors (DSPs), etc.), embedded controllers, hardwired circuitry, and/or any other suitable hardware or software component. Besides what is described herein, various modifications may be made to the disclosed embodiments and implementations of the invention without departing from their scope.

FIG. 7 illustrates a block diagram of an example computing device 700 that may be suitable for use with various components of FIG. 1, the components described with respect to the timing diagram 200 of FIG. 2, the write operation 300 of FIG. 3, the technique 400 of FIG. 4, the read operation 500 of FIG. 5, and/or the technique 600 of FIG. 6, in accordance with various embodiments.

As shown, computing device 700 may include one or more processors or processor cores 702 and system memory 704. For the purpose of this application, including the claims, the terms “processor” and “processor cores” may be considered synonymous, unless the context clearly requires otherwise. The processor 702 may include any type of processors, such as a central processing unit (CPU), a microprocessor, and the like. The processor 702 may be implemented as an integrated circuit having multi-cores, e.g., a multi-core microprocessor. In some embodiments, processors 702, in addition to cores, may further include hardware accelerators, e.g., hardware accelerators implemented with Field Programmable Gate Arrays (FPGA). The computing device 700 may include mass storage devices 706 (such as diskette, hard drive, non-volatile memory (NVM) (e.g., compact disc read-only memory (CD-ROM), digital versatile disk (DVD), any other type of suitable NVM, and so forth). In general, system memory 704 and/or mass storage devices 706 may be temporal and/or persistent storage of any type, including, but not limited to, volatile and non-volatile memory, optical, magnetic, and/or solid state mass storage, and so forth. Volatile memory may include, but is not limited to, static and/or dynamic random access memory (DRAM). Non-volatile memory may include, but is not limited to, electrically erasable programmable read-only memory, phase change memory, resistive memory, and so forth. In some embodiments, the mass storage devices 706 may include the first SSD 120, the second SSD 122, the first SSD 304, and/or the second SSD 310 described with respect to FIG. 1, FIG. 3, FIG. 5, or some other Figure.

The computing device 700 may further include I/O devices 708 (such as a display (e.g., a touchscreen display), keyboard, cursor control, remote control, gaming controller, image capture device, and so forth) and communication interfaces 710 (such as network interface cards, modems, infrared receivers, radio receivers (e.g., Bluetooth), and so forth), one or more antennas, and/or any other suitable component.

The communication interfaces 710 may include communication chips (not shown for clarity) that may be configured to operate the computing device 700 in accordance with a local area network (LAN) (e.g., Ethernet) and/or a Global System for Mobile Communication (GSM), General Packet Radio Service (GPRS), Universal Mobile Telecommunications System (UMTS), High Speed Packet Access (HSPA), Evolved HSPA (E-HSPA), or Long-Term Evolution (LTE) network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication interfaces 710 may operate in accordance with other wireless protocols in other embodiments.

In various embodiments, computing device 700 may include a data storage apparatus 752 that may include a redundancy logic 754, a storage region controller 756, and/or a storage region buffer 758. In some embodiments, the data storage apparatus 752 or components thereof may be coupled with other components of the computing device 700. In some embodiments, the data storage apparatus 752 may include a different number of components (e.g., storage region buffer 758 may be located in memory 704 or mass storage 706) or may include additional components of computing device 700 (e.g., processor 702 and/or memory 704 may be a part of data storage apparatus 752). In some embodiments, the storage region controller 756 may be configured in similar fashion to the storage region controller 102 described with respect to FIG. 1, the redundancy logic 754 may be configured in similar fashion to the redundancy logic 146 described with respect to FIG. 1, and/or the storage region buffer 758 may be configured in similar fashion to the storage region buffer 148 described with respect to FIG. 1 and/or the storage region buffer 312 described with respect to FIG. 3. In some embodiments, the storage region buffer 758 may be a storage region write-back cache.

In some embodiments, one or more components of the data storage apparatus 752 (e.g., the redundancy logic 754 and the storage region controller 756) may be included in a hardware device such as a storage controller card instead of being included as part of an OS as described with respect to the storage region controller 102 and the redundancy logic 146 of FIG. 1. In some embodiments, the storage controller card may be a card that may be inserted into a receptacle of a host system, such as a receptacle to receive a PCIe card for coupling to a PCIe bus. In some embodiments where one or more components of the data storage apparatus 752 are included in a hardware device, there may still be one or more components included as a driver, a component of a storage stack, and/or a component of an OS to direct storage I/O operations to be handled by the hardware device that includes the one or more components of the data storage apparatus 752.

The above-described computing device 700 elements may be coupled to each other via system bus 712, which may represent one or more buses. In the case of multiple buses, they may be bridged by one or more bus bridges (not shown). Each of these elements may perform its conventional functions known in the art. In particular, system memory 704 and mass storage devices 706 may be employed to store a working copy and a permanent copy of the programming instructions for the operation of various components of computing device 700, including but not limited to an operating system of computing device 700, one or more applications, operations associated with computing device 700, and/or operations associated with data storage apparatus 752, collectively denoted as computational logic 722. The various elements may be implemented by assembler instructions supported by processor(s) 702 or high-level languages that may be compiled into such instructions. In some embodiments, the computing device 700 may be implemented as a fixed function ASIC, a FPGA, or any other suitable device with or without programmability or configuration options.

The permanent copy of the programming instructions may be placed into mass storage devices 706 in the factory, or in the field through, for example, a distribution medium (not shown), such as a compact disc (CD), or through communication interface 710 (from a distribution server (not shown)). That is, one or more distribution media having an implementation of the agent program may be employed to distribute the agent and to program various computing devices.

The number, capability, and/or capacity of the elements 708, 710, 712 may vary, depending on whether computing device 700 is used as a stationary computing device, such as a set-top box or desktop computer, or a mobile computing device, such as a tablet computing device, laptop computer, game console, or smartphone. Their constitutions are otherwise known, and accordingly will not be further described.

For some embodiments, at least one of processors 702 may be packaged together with computational logic 722 configured to practice aspects of embodiments described herein to form a System in Package (SiP) or a System on Chip (SoC).

In various implementations, the computing device 700 may comprise one or more components of a data center, a laptop, a netbook, a notebook, an ultrabook, a smartphone, a tablet, an ultra mobile PC, or a mobile phone. In some embodiments, the computing device 700 include one or more components of a server. In further implementations, the computing device 700 may be any other electronic device that processes data.

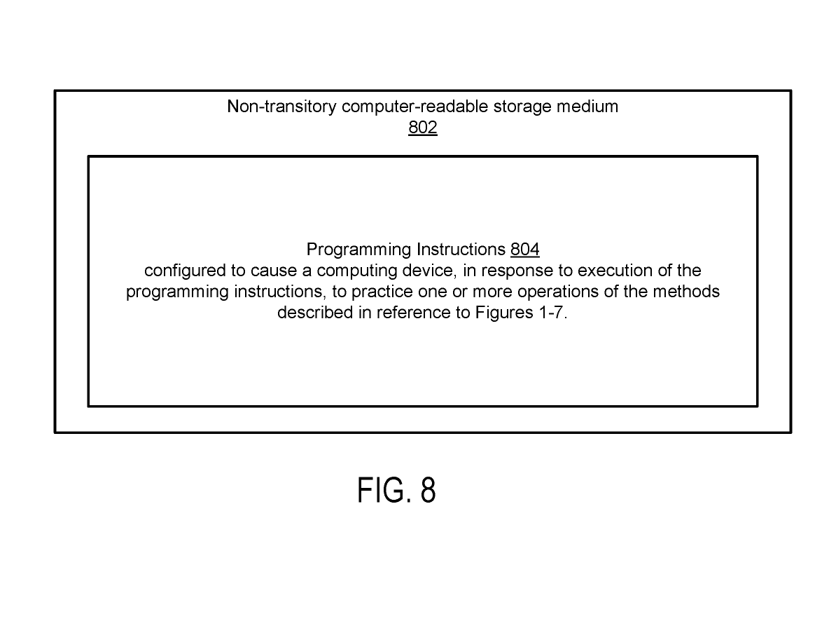

FIG. 8 illustrates an example computer-readable storage medium 802 having instructions configured to practice all or selected ones of the operations associated with the computing device 700, earlier described with respect to FIG. 7; the computer system 100, storage region controller 102, and/or the redundancy logic 146 described with respect to FIG. 1; the operations associated with the timing diagram 200 of FIG. 2; the write operation 300 described with respect to FIG. 3, the technique 400 described with respect to FIG. 4; the read operation 500 described with respect to FIG. 5; and/or the technique 600 of FIG. 6, in accordance with various embodiments.

As illustrated, computer-readable storage medium 802 may include a number of programming instructions 804. The storage medium 802 may represent a broad range of non-transitory persistent storage medium known in the art, including but not limited to flash memory, dynamic random access memory, static random access memory, an optical disk, a magnetic disk, etc. Programming instructions 804 may be configured to enable a device, e.g., part or all of the computer system 100 and/or the computing device 700, such as the storage region controller 102 and/or other components of the computer system 100, in response to execution of the programming instructions 804, to perform, e.g., but not limited to, various operations described for the storage region controller 102, the redundancy logic 146, the data storage apparatus 752 of FIG. 7, operations associated with the timing diagram 200 of FIG. 2; the write operation 300 described with respect to FIG. 3, the technique 400 described with respect to FIG. 4, the read operation 500 described with respect to FIG. 5, and/or the technique 600 of FIG. 6. In alternate embodiments, programming instructions 804 may be disposed on multiple computer-readable storage media 802. In an alternate embodiment, storage medium 802 may be transitory, e.g., signals encoded with programming instructions 804.

Referring back to FIG. 7, for an embodiment, at least one of processors 702 may be packaged together with memory having all or portions of computational logic 722 configured to practice aspects shown or described for the storage region controller 102, the redundancy logic 146 and/or other components of computer system 100 shown in FIG. 1, the computing device 700, including the data storage apparatus 752 of FIG. 7, operations associated with the timing diagram 200 of FIG. 2; the write operation 300 described with respect to FIG. 3, the technique 400 described with respect to FIG. 4, the read operation 500 described with respect to FIG. 5, and/or the technique 600 of FIG. 6. For an embodiment, at least one of processors 702 may be packaged together with memory having all or portions of computational logic 722 configured to practice aspects described for the storage region controller 102, the redundancy logic 146 and/or other components of the data storage device 100 shown in FIG. 1, the computing device 700, including the data storage apparatus 752 of FIG. 7, operations associated with the timing diagram 200 of FIG. 2, the write operation 300 described with respect to FIG. 3, the technique 400 described with respect to FIG. 4, the read operation 500 described with respect to FIG. 5, and/or the technique 600 of FIG. 6 to form a System in Package (SiP). For an embodiment, at least one of processors 702 may be integrated on the same die with memory having all or portions of computational logic 722 configured to practice aspects described for the storage region controller 102, the redundancy logic 146 and/or other components of the computer system 100 shown in FIG. 1, the computing device 700, including the data storage apparatus 752 of FIG. 7, operations associated with the timing diagram 200 of FIG. 2, the write operation 300 described with respect to FIG. 3, the technique 400 described with respect to FIG. 4, the read operation 500 described with respect to FIG. 5, and/or the technique 600 of FIG. 6. For an embodiment, at least one of processors 702 may be packaged together with memory having all or portions of computational logic 722 configured to practice aspects of the storage region controller 102, the redundancy logic 146 and/or other components of the data storage device 100 shown in FIG. 1, the computing device 700, including the data storage apparatus 752 of FIG. 7, operations associated with the timing diagram 200 of FIG. 2, the write operation 300 described with respect to FIG. 3, the technique 400 described with respect to FIG. 4, the read operation 500 described with respect to FIG. 5, and/or the technique 600 of FIG. 6 to form a System on Chip (SoC).

Machine-readable media (including non-transitory machine-readable media, such as machine-readable storage media), methods, systems and devices for performing the above-described techniques are illustrative examples of embodiments disclosed herein. Additionally, other devices in the above-described interactions may be configured to perform various disclosed techniques.

### Examples

Example 1 may include a data storage apparatus comprising: a redundancy logic to determine one or more sets of recovery data based at least in part on data in a storage region buffer; and a storage region controller, wherein the storage region controller is to: schedule a first set of one or more non-volatile memory (NVM) dies in a first solid state drive (SSD) to be in a non-deterministic (ND) state or a deterministic (D) state; schedule a second set of one or more NVM dies in a second SSD to be in a ND state or a D state; issue a first write command to write the data to the first set of one or more NVM dies when the first set of NVM dies are in the ND state; and issue a second write command to write the recovery data to the second set of one or more NVM dies when the second set of NVM dies are in the ND state.

Example 2 may include the subject matter of Example 1, wherein the recovery data is a copy of the data.

Example 3 may include the subject matter of Example 1, wherein the storage region controller is further to schedule a third set of one or more NVM dies to be in a ND state or a D state, the data in the storage region buffer includes a first data element to be written to the first set of one or more NVM dies and a second data element to be written to the third set of one or more NVM dies, and the recovery data is parity data based at least in part on the first data element and the second data element.

Example 4 may include the subject matter of Example 3, wherein the third set of one or more NVM dies is in the second SSD.

Example 5 may include the subject matter of any one of Examples 3-4, wherein the redundancy logic is to determine the parity data based on an XOR operation of the first data element and the second data element.

Example 6 may include the subject matter of Example 5, wherein in response to a read request for the first data element stored in the first set of one or more NVM dies, the storage region controller is to: determine whether the first set of one or more NVM dies is in the D state; issue a command to return the requested data from the first set of one or more NVM dies in response to the first set of one or more NVM dies is in the D state; and issue a command to return the requested data based at least in part on an XOR operation of the second data element and the parity data in response to the first set of one or more NVM dies is in the ND state.

Example 7 may include the subject matter of any one of Examples 1-6, wherein the storage region controller is further to evict the data from the storage region buffer in response to the recovery data has been written to one or more of the first set of NVM dies or the second set of NVM dies.

Example 8 may include the subject matter of any one of Examples 1-7, wherein the storage region controller is to store the data in the storage region buffer in response to a received write request from an application, and wherein the redundancy logic is to determine the one or more sets of recovery based at least in part on the stored data.

Example 9 may include the subject matter of any one of Examples 1-8, wherein the storage region controller is to schedule the first set of one or more NVM dies and the second set of one or more NVM dies via an open channel SSD interface.

Example 10 may include the subject matter of any one of Examples 1-8, wherein the storage region controller is to schedule the first set of one or more NVM dies and the second set of one or more NVM dies via a NVM Express (NVMe) interface.

Example 11 may include the subject matter of anyone of Examples 1-10, wherein in response to a read request for requested data, the storage region controller is to: determine whether the requested data has been written to one or more of the first set of one or more NVM dies or the second set of one or more NVM dies; and issue a command to return the requested data from the storage region buffer in response to the requested data is in the storage region buffer but has not been written to one or more of the first set of one or more NVM dies or the second set of one or more NVM dies.

Example 12 may include the subject matter of any one of Examples 1-10, wherein in response to a read request for requested data stored in the first set of one or more NVM dies, the storage region controller is to: determine whether the first set of one or more NVM dies is in the D state; issue a command to return the requested data from the first set of one or more NVM dies in response to the first set of one or more NVM dies are in the D state; and issue a command to return the requested data based at least in part on the recovery data in response to the first set of one or more NVM dies are in the ND state.

Example 13 may include the subject matter of any one of Examples 1-12, wherein the redundancy logic and the storage region controller are included in a storage controller.

Example 14 may include the subject matter of any one of Examples 1-13, wherein the storage controller includes a Peripheral Component Interconnect Express (PCIe) interface for communication with a host device.

Example 15 may include the subject matter of any one of Examples 1-14, further comprising the storage region buffer.

Example 16 may include the subject matter of any one of Examples 1-15, wherein the first set of one or more NVM dies is a first set of NAND dies grouped into a first contiguous logical block addressing (LBA) space, and the second set of one or more NVM dies is a second set of NAND dies grouped into a second contiguous LBA space.

Example 17 may include the subject matter of any one of Examples 1-16, further comprising the first SSD and the second SSD.

Example 18 may include a method of performing nonvolatile storage input/output operations comprising: determining one or more sets of recovery data based at least in part on data in a storage region buffer; scheduling a first set of one or more non-volatile memory (NVM) dies in a first solid state drive (SSD) to be in a non-deterministic (ND) state or a deterministic (D) state; scheduling a second set of one or more NVM dies in a second SSD to be in a ND state or a D state; issuing a first write command to write the data to the first set of one or more NVM dies when the first set of NVM dies are in the ND state; and issuing a second write command to write the recovery data to the second set of one or more NVM dies when the second set of NVM dies are in the ND state.

Example 19 may include the subject matter of Example 18, further comprising: scheduling a third set of one or more NVM dies to be in a ND state or a D state, wherein the data in the storage region buffer includes a first data element to be written to the first set of one or more NVM dies and a second data element to be written to the third set of one or more NVM dies, and wherein the recovery data is parity data based at least in part on the first data element and the second data element.

Example 20 may include the subject matter of Example 19 further comprising: determining whether the first set of one or more NVM dies is in the D state in response to a read request for a first data element stored in the first set of one or more NVM dies; issuing a command to return the requested data from the first set of one or more NVM dies in response to the first set of one or more NVM dies is in the D state; and issuing a command to return the requested data based at least in part on an XOR operation of the second data element and the parity data in response to the first set of one or more NVM dies is in the ND state.

Example 21 may include the subject matter of any one of Examples 18-20, further comprising evicting the data from the storage region buffer in response to the recovery data has been written to one or more of the first set of NVM dies or the second set of NVM dies.

Example 22 may include at least one non-transitory computer-readable medium comprising instructions stored thereon that, in response to execution of the instructions by one or more processors cause a computing device to: store data in a storage region buffer in response to a received write request; determine one or more sets of recovery data based at least in part on the stored data in the storage region buffer; schedule a first set of one or more non-volatile memory (NVM) dies in a first solid state drive (SSD) to be in a non-deterministic (ND) state or a deterministic (D) state; schedule a second set of one or more NVM dies in a second SSD to be in a ND state or a D state; write a first data element to the first set of one or more NVM dies while the first set of one or more NVM dies are in the ND state, based at least in part on the data; and write a recovery data element to the second set of one or more NVM dies while the second set of one or more NVM dies are in the ND state, based at least in part on the recovery data.

Example 23 may include the subject matter of Example 22, wherein the instructions are further to cause the computing device to schedule a third set of one or more NVM dies to be in a ND state or a D state, wherein the data in the storage region buffer includes the first data element and a second data element to be written to the third set of one or more NVM dies, and wherein the recovery data element is parity data based at least in part on the first data element and the second data element.

Example 24 may include the subject matter of Example 23, wherein the instructions are further to cause the computing device to, in response to a read request for the first data element stored in the first set of one or more NVM dies: issue a command to return the requested data from the first set of one or more NVM dies in response to the first set of one or more NVM dies is in the D state; and issue a command to return the requested data based at least in part on an XOR operation of the second data element and the recovery data element in response to the first set of one or more NVM dies is in the ND state.

Example 25 may include the subject matter of any one of Examples 22-24, wherein the instructions are to cause the computing device to schedule the first set of one or more NVM dies and the second set of one or more NVM dies via an open channel solid state drive (SSD) interface or a NVM Express (NVMe) interface.

Example 26 may include an apparatus comprising means for performing the method of any one of Examples 18-21, or some other Example herein.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions stored thereon that, when executed, result in actions of any of the above-described embodiments. Moreover, some embodiments may include apparatuses or systems having any suitable means for carrying out the various operations of the above-described embodiments.

The above description of illustrated implementations, including what is described in the Abstract, is not intended to be exhaustive or to limit the embodiments of the present disclosure to the precise forms disclosed. While specific implementations and examples are described herein for illustrative purposes, various equivalent modifications are possible within the scope of the present disclosure, as those skilled in the relevant art will recognize.

These modifications may be made to embodiments of the present disclosure in light of the above detailed description. The terms used in the following claims should not be construed to limit various embodiments of the present disclosure to the specific implementations disclosed in the specification and the claims. Rather, the scope is to be determined entirely by the following claims, which are to be construed in accordance with established doctrines of claim interpretation.

We claim:

1. A data storage apparatus comprising:
a redundancy logic to determine one or more sets of recovery data based at least in part on data in a storage region buffer; and
a storage region controller, wherein the storage region controller is to:
schedule a first set of one or more non-volatile memory (NVM) dies in a first solid state drive (SSD) to be in a non-deterministic (ND) state or a deterministic (D) state;
schedule a second set of one or more NVM dies in a second SSD to be in a ND state or a D state;
issue a first write command to write the data to the first set of one or more NVM dies when the first set of NVM dies are in the ND state; and
issue a second write command to write the recovery data to the second set of one or more NVM dies when the second set of NVM dies are in the ND state.

2. The data storage apparatus of claim 1, wherein the recovery data is a copy of the data.

3. The data storage apparatus of claim 1, wherein the storage region controller is further to schedule a third set of one or more NVM dies to be in a ND state or a D state, the data in the storage region buffer includes a first data element to be written to the first set of one or more NVM dies and a second data element to be written to the third set of one or more NVM dies, and the recovery data is parity data based at least in part on the first data element and the second data element.

4. The data storage apparatus of claim 3, wherein the third set of one or more NVM dies is in the second SSD.

5. The data storage apparatus of claim 3, wherein the redundancy logic is to determine the parity data based on an XOR operation of the first data element and the second data element.

6. The data storage apparatus of claim 1, wherein the storage region controller is further to evict the data from the storage region buffer in response to the recovery data has been written to one or more of the first set of NVM dies or the second set of NVM dies.

7. The data storage apparatus of claim 1, wherein the storage region controller is to store the data in the storage region buffer in response to a received write request from an application, and wherein the redundancy logic is to determine the one or more sets of recovery based at least in part on the stored data.

8. The data storage apparatus of claim 1, wherein in response to a read request for requested data, the storage region controller is to:
determine whether the requested data has been written to one or more of the first set of one or more NVM dies or the second set of one or more NVM dies; and
issue a command to return the requested data from the storage region buffer in response to the requested data is in the storage region buffer but has not been written to one or more of the first set of one or more NVM dies or the second set of one or more NVM dies.

9. The data storage apparatus of claim 1, wherein in response to a read request for requested data stored in the first set of one or more NVM dies, the storage region controller is to:
determine whether the first set of one or more NVM dies is in the D state;
issue a command to return the requested data from the first set of one or more NVM dies in response to the first set of one or more NVM dies are in the D state; and
issue a command to return the requested data based at least in part on the recovery data in response to the first set of one or more NVM dies are in the ND state.

10. The data storage apparatus of claim 1, wherein the redundancy logic and the storage region controller are included in a storage controller.

11. The data storage apparatus of claim 10, wherein the storage controller includes a Peripheral Component Interconnect Express (PCIe) interface for communication with a host device.

12. The data storage apparatus of claim 10, further comprising the storage region buffer.

13. The data storage apparatus of claim 1, further comprising the first SSD and the second SSD.

14. A method of performing nonvolatile storage input/output operations comprising:
determining one or more sets of recovery data based at least in part on data in a storage region buffer;
scheduling a first set of one or more non-volatile memory (NVM) dies in a first solid state drive (SSD) to be in a non-deterministic (ND) state or a deterministic (D) state;
scheduling a second set of one or more NVM dies in a second SSD to be in a ND state or a D state;
issuing a first write command to write the data to the first set of one or more NVM dies when the first set of NVM dies are in the ND state; and
issuing a second write command to write the recovery data to the second set of one or more NVM dies when the second set of NVM dies are in the ND state.

15. The method of claim 14, further comprising: scheduling a third set of one or more NVM dies to be in a ND state or a D state, wherein the data in the storage region buffer includes a first data element to be written to the first set of one or more NVM dies and a second data element to be written to the third set of one or more NVM dies, and wherein the recovery data is parity data based at least in part on the first data element and the second data element.

16. The method of claim 15 further comprising:
determining whether the first set of one or more NVM dies is in the D state in response to a read request for a first data element stored in the first set of one or more NVM dies;
issuing a command to return the requested data from the first set of one or more NVM dies in response to the first set of one or more NVM dies is in the D state; and
issuing a command to return the requested data based at least in part on an XOR operation of the second data element and the parity data in response to the first set of one or more NVM dies is in the ND state.

17. At least one non-transitory computer-readable medium comprising instructions stored thereon that, in response to execution of the instructions by one or more processors cause a computing device to:
store data in a storage region buffer in response to a received write request;
determine one or more sets of recovery data based at least in part on the stored data in the storage region buffer;
schedule a first set of one or more non-volatile memory (NVM) dies in a first solid state drive (SSD) to be in a non-deterministic (ND) state or a deterministic (D) state;
schedule a second set of one or more NVM dies in a second SSD to be in a ND state or a D state;
write a first data element to the first set of one or more NVM dies while the first set of one or more NVM dies are in the ND state, based at least in part on the data; and
write a recovery data element to the second set of one or more NVM dies while the second set of one or more NVM dies are in the ND state, based at least in part on the recovery data.

18. The at least one non-transitory computer-readable medium of claim 17, wherein the instructions are further to cause the computing device to schedule a third set of one or more NVM dies to be in a ND state or a D state, wherein the data in the storage region buffer includes the first data element and a second data element to be written to the third set of one or more NVM dies, and wherein the recovery data element is parity data based at least in part on the first data element and the second data element.

19. The at least one non-transitory computer-readable medium of claim 18, wherein the instructions are further to cause the computing device to, in response to a read request for the first data element stored in the first set of one or more NVM dies:
issue a command to return the requested data from the first set of one or more NVM dies in response to the first set of one or more NVM dies is in the D state; and
issue a command to return the requested data based at least in part on an XOR operation of the second data element and the recovery data element in response to the first set of one or more NVM dies is in the ND state.

20. The at least one non-transitory computer-readable medium of claim 17, wherein the instructions are to cause the computing device to schedule the first set of one or more NVM dies and the second set of one or more NVM dies via an open channel solid state drive (SSD) interface or a NVM Express (NVMe) interface.
